(19) United States
(12) Patent Application Publication
(10) Pub. No.: US 2014/0136225 A1
(43) Pub. Date: May 15, 2014

(54) DISCHARGE READINESS INDEX

(71) Applicant: Omar Badawi, Baltimore, MD (US)

(72) Inventor: Omar Badawi, Baltimore, MD (US)

(73) Assignee: KONINKLIJKE PHILIPS N.V., EINDHOVEN (NL)

(21) Appl. No.: 14/125,327

(22) PCT Filed: Jun. 18, 2012
(86) PCT No.: PCT/IB2012/053047

§ 371 Date: Dec. 11, 2013

Related U.S. Application Data
(60) Provisional application No. 61/500,647, filed on Jun. 24, 2011.

(51) Int. Cl. G06F 19/00

(52) U.S. Cl. CPC G06F 19/3431
USPC 705/2

(57) ABSTRACT

A system (16) assesses the readiness of a patient to be discharged from an intensive care unit (ICU), hospital or other monitored clinical care setting to a less intensively monitored location. The system (16) includes one or more processor (46). The processors (46) are programmed to receive patient data for patients. Risks of death from discharge for the patients are calculated using a first predictive model of risk of death. Further, risks of readmission from discharge for the patients are calculated using a second predictive model of risk of readmission. Risks of death and/or risks of readmission for one or more of the patients are presented to a clinician or clinicians in different groups of risk to supplement discharge decisions by clinicians.

The present application relates to clinical decision making It finds particular application in conjunction with clinical decision support systems and will be described with particular reference thereto. However, it is to be understood that it also finds application in other usage scenarios and is not necessarily limited to the aforementioned application.

Prolonged duration of stay in a monitored clinical environment such as, the intensive care unit (ICU), leads to many adverse clinical and financial outcomes. The average cost for a hospital to keep a patient in an ICU bed for one day is approximately three times greater than that of a regular hospital bed. Assuming patients receive a constant quality of care, decreasing length of stay (LOS) increases revenue for hospitals by improving throughput and increasing the number of patients that can be cared for. Patients also benefit from shorter stays because of the disruptive environment found in many monitored clinical environments, such as hospitals and ICUs. Therefore, early discharge to less intensively monitored environments has many benefits.

Despite the many benefits of early discharge, it is not without risk. If patients requiring intensive care are discharged before they are stable enough for less intensive monitoring and care, they are at risk for complications, such as unexpected readmission or even death. In addition to the increased stress placed on patients and families, patients readmitted tend to have higher risk-adjusted mortality.

Determining when acutely ill patients are stable enough to be discharged to a less intensively monitored area has traditionally been a subjective decision by the attending physician in collaboration with other members of the care team. Due to the highly subjective nature of this decision, there is a great deal of variability in determining when patients are discharged. Although many of the causes of unexpected readmission or death after discharge are likely related to the care provided after discharge, presumably the closer the proximity between discharge and readmission or death, the more likely the patient was not ‘ready’ to be discharged.

Numerous studies have evaluated predictors of death or readmission and identified variables that predict these complications. Predictors of death or readmission after ICU discharge previously identified include the ICU LOS, the Glasgow Coma Scale at the time of ICU discharge, the mean arterial pressure and the original source of the ICU admission.

Although many predictors have been identified for ICU patients, a reliable and valid clinical decision support system has yet to be identified. The Stability and Workload Index for Transfer (SWIFT) score was designed to facilitate this by identifying readmission or death within one week of ICU discharge. Two primary features of the SWIFT score were its simplicity (designed to be calculated without the aid of a computer) and the designation of a specific score, such as 15 out of 64, to identify patients at risk for readmission or death. The model produced moderate discrimination but the results did not reproduce well in the validation arm of the study. Although there were many strengths to the study, some potential reasons for the limited applicability of this score may have been the model was developed on patients with an extended length of time between ICU discharge and complication (one week) and the relatively small number of patients from a single hospital with an event (100 readmissions and 5 deaths).

Further, there appear to be significant factors unrelated to the stability of a patient at time of discharge that influence readmission of a patient to an ICU and cannot effectively be captured in a predictive model. These may include local culture of a hospital and attending physicians, patient and family influence, and relationships or rapport between clinical staff in different hospital units.

The present application provides new and improved methods and systems which overcome the above-referenced problems and others.

In accordance with one aspect, a system for assessing the readiness of a patient to be discharged from an intensive care unit (ICU), hospital or other monitored clinical care setting to a less intensively monitored hospital unit is provided. The system includes one or more processor. The processors are programmed to receive patient data for patients. Risks of death from discharge for the patients are calculated using a first predictive model of risk of death. Further, risks of readmission for the patients are calculated using a second predictive model of risk of readmission. A risk of discharge is determined from the risks of death and the risks of readmission presented for one or more of the patients to a clinician or clinicians.

In accordance with another aspect, a method for assessing the readiness of a patient to be discharged from an intensive care unit (ICU), hospital or other monitored clinical care setting to a less intensively monitored hospital unit is provided. Patient data for patients is received. Risks of death from discharge for the patients are calculated using a first predictive model of risk of death. Risks of readmission for the patients are calculated using a second predictive model of risk of readmission. A risk of discharge is determined from the risks of death and the risks of readmission presented for one or more of the patients to a clinician or clinicians.

One advantage is that risk of death and risk of readmission after discharge from an ICU can be reliably predicted.

Another advantage is that risk of death and risk of readmission after discharge from an ICU can be objectively predicted.

Another advantage is that differences in predictive variables and outcome (e.g., death and readmission) are taken in to account.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

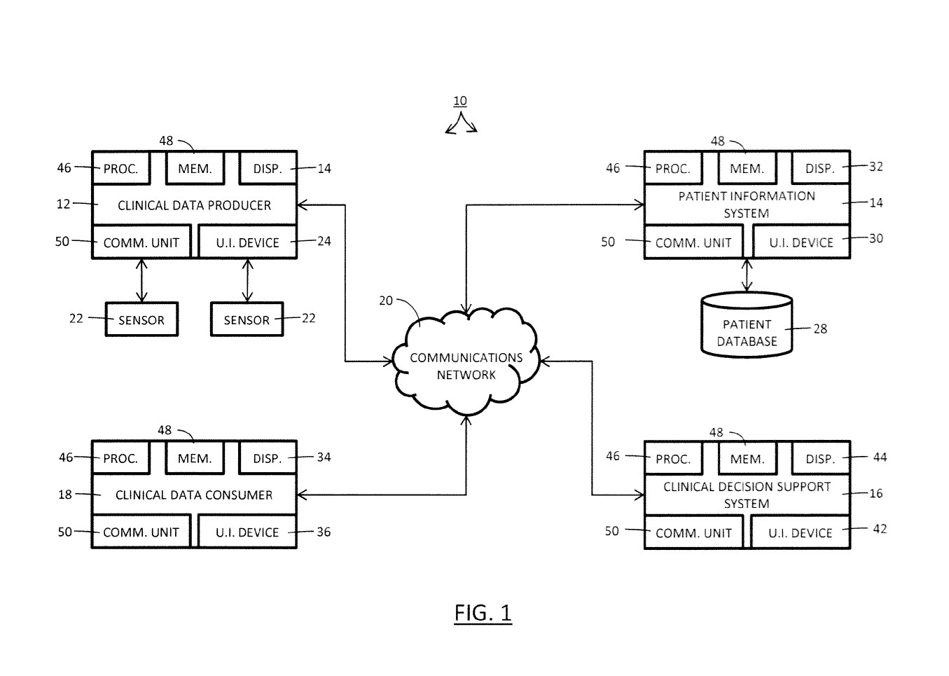

FIG. 1 is a block diagram of an IT infrastructure of an intensive care unit.

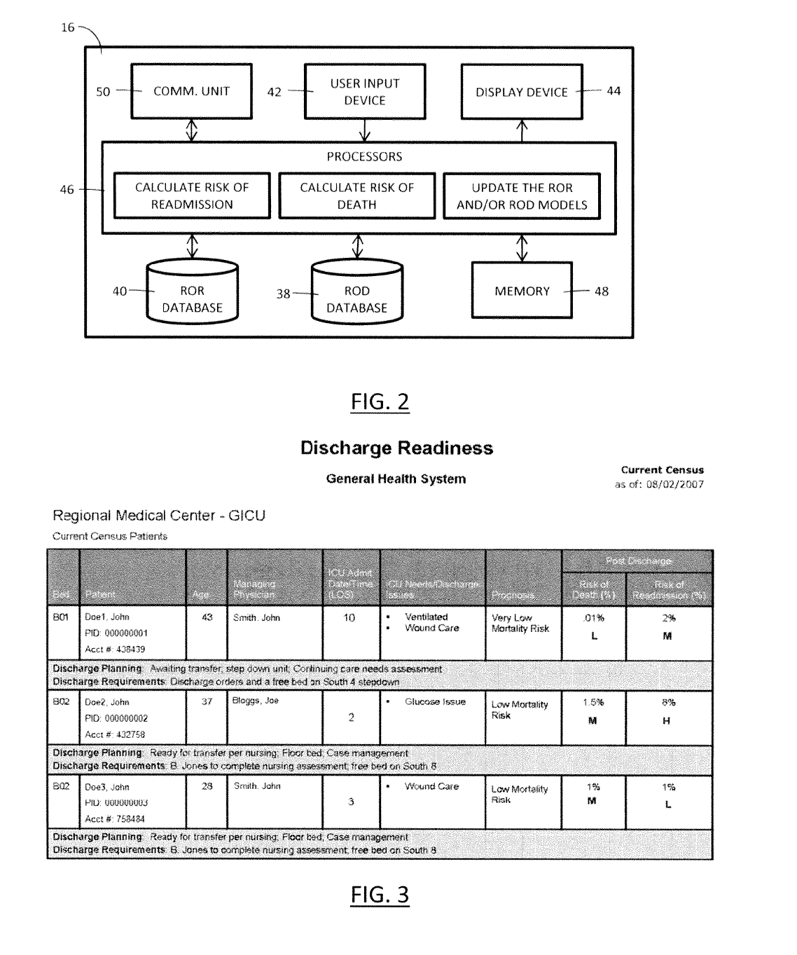

FIG. 2 is a block diagram of a clinical decision support system.

FIG. 3 is an example of a report including risk of death and risk of readmission for a plurality of patients.

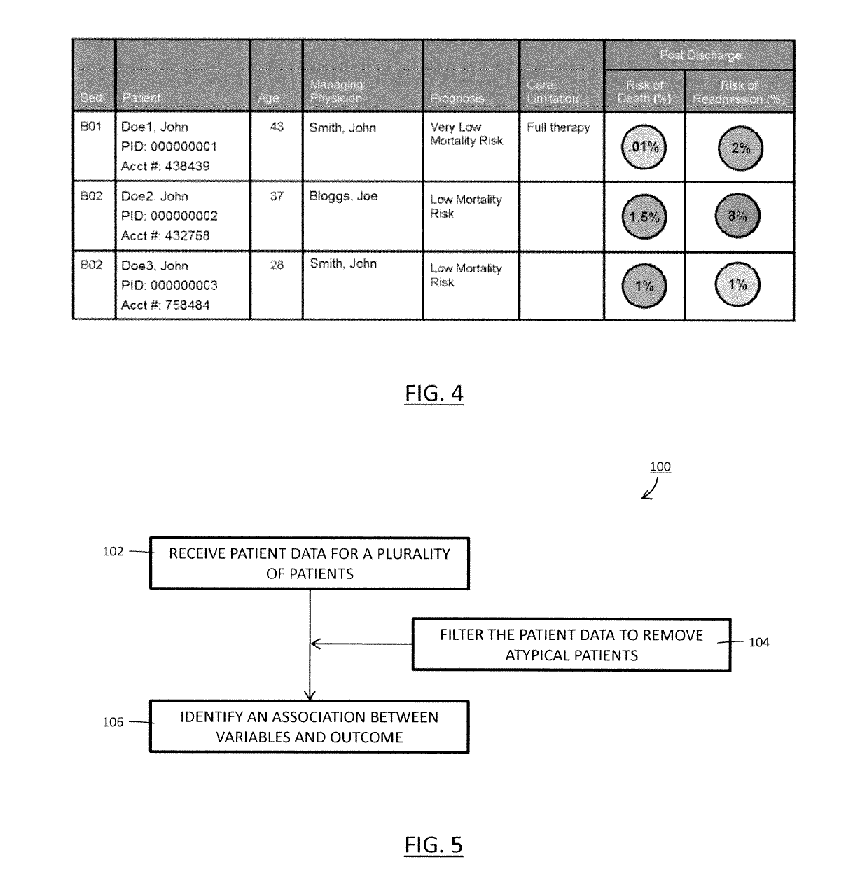

FIG. 4 is an example of a user interface including risk of death and risk of readmission for a plurality of patients.

FIG. 5 is a block diagram of a method for generating a linear regression model.

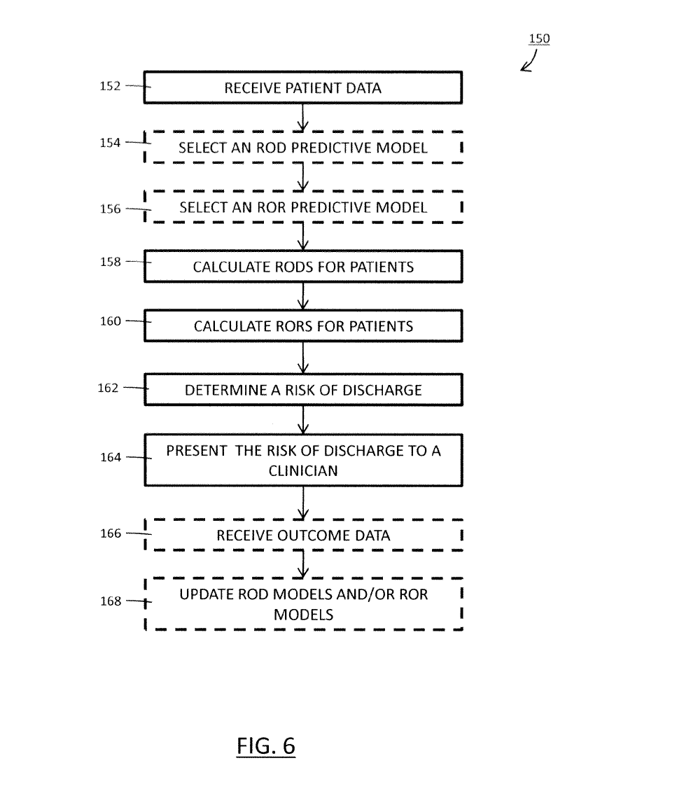

FIG. 6 is a block diagram of a method for assessing the readiness of a patient to be discharged from an intensive care unit (ICU).

With reference to FIGS. 1 and 2, an information technology (IT) infrastructure 10 of an intensive care unit (ICU) includes one or more clinical data producers 12, optionally a patient information system 14, a clinical decision support system (CDSS) 16, one or more clinical data consumers 18, and the like. Suitably, the components of the IT infrastructure 10 are interconnected via a communications network 20, such as the Internet, a local area network, a wide area network, a wireless network, or the like.

The clinical data producers 12 generate patient data for corresponding patients cared for in the ICU. The patient data suitably includes data indicative of one or more physiological parameters, such as heart rate, temperature, blood oxygen saturation, level of consciousness, concern, pain, urine output, and so on. The patient data can be generated continuously and/or upon the happening of an event, such as a timer event, a user input event, and so on. Further, the patient data can be generated automatically and/or manually. As to the former, sensors 22, such electrocardiographic (ECG) electrodes, blood pressure sensors, SpO2 sensors, and so on, measuring physiological parameters of patients can be employed. As to the latter, user input devices 24 can be employed. In some embodiments, the clinical data producers 12 include display devices 26 providing users a user interface within which to manually enter the patient data and/or for displaying generated patient data to clinicians. Examples of clinical data producers include, but are not limited to, patient monitors, nursing stations, mobile communications devices, patient information systems, and so on.

The patient information system 14 stores patient data from the IT infrastructure 10, such as from the clinical data producers 12 and/or the CDSS 16, in one or more databases 28 of the IT infrastructure 10. For example, the patient information system 14 can store a risk of discharge, such as a risk of death and/or a risk of readmission, for a patient from the CDSS 16, discussed hereafter. As another example, the patient information system 14 can store respiration rate for a patient from one of the clinical data producers 12. In some embodiments, the patient information system also store patient data from user input devices 30 in the database 28 and/or allows stored patient data to be viewed on display devices 32. The display devices 32 can also be used to facilitate receipt of data from the user input devices 30. Examples of patient information systems include, but are not limited to, electronic medical record systems, departmental systems, and the like.

The CDSS 16 receives patient data from the IT infrastructure 10, such as from the clinical data producers 12 and/or the patient information system 14. It is also contemplated that the patient data can be received from user input devices 34, optionally with display devices 36 providing users a user interface within which to enter the patient data. Using the patient data, the CDSS 16 evaluates the risks of discharging the patients from the ICU based both on risk of death (ROD) and risk of readmission (ROR). In some embodiments, the ROD and/or the ROR correspond to death or readmission within a predetermined period of time, such as 48 hours. Advantageously, by separating the ROD and the ROR, differences in the relationships between predictive variables and outcomes for ROD and ROR can be accounted for. In some embodiments, the RODs and/or RORs for patients are displayed on the display devices 36. The ROR and/or ROD can be calculated continuously as patient data is received and/or upon the happening of an event, such as a timer event, a user input event, and so on. For example, a clinician can manually trigger calculation of an ROD and/or an ROR for a patient so as to determine whether the patient is suitable for discharge from the ICU.

ROD for a patient is calculated by inputting patient data, including values for predictive variables, received for the patient to an ROD model that predicts the ROD for a patient using the predictive variables. In some embodiments, the ROD model is selected from a plurality of ROD models in an ROD database 38. Similar to ROD, ROR for a patient is calculated by inputting patient data, including values for predictive variables, received for the patient to an ROR model that predicts ROR for a patient using the predictive variables. In some embodiments, the ROR model is selected from an ROR database 40. Suitably, the predictive variables used by the ROD model and the ROR model need not be the same. Further, the models employed for calculating ROD and/or ROR include any variety of predictive model methodologies, such as logistic regression, mulinomial logistic regression, linear regression and support vector machine learning , which are suitably defined by a plurality of coefficients, support vectors or similar factors corresponding to predictive variables. One approach for generating logistic regression models for assessing ICU discharge readiness is discussed hereafter in connection with FIG. 5. Further, the risks produced by the models are suitably probabilities. However, the risks need not be probabilities. For example, the risks can be scores, such as 1 to 10 or 1 to 100, in order of increasing severity.

The CDSS 16 further receives outcome data from the IT infrastructure 10, such as the patient information system 14, and/or an external database, such as the eICU® Program database. It is also contemplated that the outcome data can be received from the user input devices 34, optionally with the display devices 36 providing users a user interface within which to enter the outcome data. Outcome data is a species of patient data and indicates whether a patient was readmitted after discharge or died after discharge, from the ICU, and the surrounding circumstances. Based on the outcome data, the CDSS 16 updates the predictive models used to calculate ROD and ROR. When the predictive models are logistic regression models, the models can be updated according to approach discussed hereafter in connection with FIG. 5. It is contemplated that the predictive models are updated continuously as outcome data is received or updated upon the happening of an event, such as a timer event, a user input event, and so on. In some embodiments, newer outcome data is weighted more heavily than older outcome data when updating the predictive models.

The clinical data consumers 18 consume patient data received from the IT infrastructure 10, such as from the clinical data producers 12, the CDSS 18, the patient information system 14, and so on, for the patients cared for in the ICU. For example, the clinical data consumers 18 can receive RORs and/or RODs from the CDSS 18. As another example, the clinical data consumers 18 can receive respiration rate and heart rate from the clinical data producers 12. In some embodiments, the clinical data consumers 18 also receive patient data from user input devices 42, optionally with display devices 44 providing users a user interface within which to enter the patient data. Suitably, the received patient data includes at least ROD and ROR for at least one patient. Examples of clinical data consumers include, but are not limited to, patient monitors, nursing stations, mobile communications devices, patient information systems, clinical decision support systems, and so on.

Consumption can include processing the received patient data to generate additional patient data and/or consolidating the patient data into reports. A report is a computer file in a format, such as PDF, DOCX, DOC, and so on. In some embodiments, newly generated patient data and/or newly generated reports are saved in the IT infrastructure 10, such as in the patient information system 14. Further, in some embodiments, newly generated reports are electronically messaged to clinicians using, for example, email and/or printed using, for example, a laser printer, an inkjet printer and so on. Consumption can also include displaying the received patient data for at least one patient on a user interface presented to clinicians via the display devices 44. In some embodiments, the user interface is continuously updated as patient data is received. Advantageously, this allows clinicians to monitor patients ROD and/or ROR in real time.

When displaying patient data and/or generating a report, the report and/or display suitably includes at least patient name, ROD and ROR for at least one patient. Where the received patient data includes patient data for a plurality of patients, the received patient data is suitably formatted in a table structure with a plurality of rows corresponding to the patients. In some embodiments, the rows are sorted and/or can be sorted by severity of ROD and/or ROR. For example, a clinician can employ the user input devices 42 to sort a table of patient data based on ROD and/or ROR. Further, in some embodiments, clinicians can selectively view the details of an ROD and/or ROR. For example, a clinician can employ the user input devices 42 to select an ROD and/or ROR for a patient and view the variables and respective values that yielded the ROD and/or ROR, optionally ranked based on contribution. Even more, in some embodiments, the patient data can be grouped based on similar ROD and/or ROR. Groups include, for example, one or more of very low risk, low risk, moderate risk, high risk, and so on.

ROD and/or ROR can be represented as one or more of textual values (e.g., a scores, probabilities, and so on), icons (e.g., one or more of shape, color, background and so on based on severity), a combination of the foregoing, and so on in a user interface and/or a report. For example, an ROD or an ROR can be represented as a circle having a background color dependent upon severity, such as red for high risk, yellow for medium risk and green for low risk. In some embodiments, an icon further includes a textual value overlaid thereon, optionally depending upon severity. For example, an icon can include a probability overlaid thereon when the severity is medium.

With reference to FIG. 3, an example report is illustrated. The report includes a plurality of rows, each including patient data for a different patient. Each row includes a patient name, a ROD, a ROR, age, prognosis, and so on. The ROD and the ROR are presented as probabilities and textual severity indicators (i.e., “L”, “M”, and “H” for low, medium and high, respectively). With reference to FIG. 4, an example user interface for patient data is illustrated. Similar to the report, the user interface includes a plurality of rows, each including patient data for a different patient. Further, each row includes a ROD and a ROR represented as an icon with a probability overlaid thereon. Notably, the backgrounds of the icons are color coded based on severity, where severity increases with the darkness of background color.

Referring back to FIGS. 1 and 2, the components of the IT infrastructure 10 suitably include processors 46 executing computer executable instructions embodying the foregoing functionality, where the computer executable instructions are stored on memories 48 associated with the processors 46. It is, however, contemplated that at least some of the foregoing functionality can be implemented in hardware without the use of processors. For example, analog circuitry can be employed. Further, the components of the IT infrastructure 10 include communication units 50 providing the processors 46 an interface from which to communicate over the communications network 20. Even more, although the foregoing components of the IT infrastructure 10 were discretely described, it is to be appreciated that the components can be combined. For example, the clinical data consumers 12 and the clinical data producers 18 can be the same and/or have overlap. As another example, the CDSS 16 can be integrated with the clinical data consumers 18 and/or the clinical data producers 12. As yet another example, the CDSS 16, the data consumers 18 and the clinical data producers 12 can be combined into a standalone device independent from the communications network 20.

With reference to FIG. 5, a method 100 for developing logistic regression models includes receiving 102 patient data, including outcome data, for a plurality of patients discharged from one or more ICUs. Suitably, the patient data includes a record for each of the plurality of patients, where each record includes a plurality of variables potentially relevant to predicting ROD and/or ROR and the outcome after discharging the patient from the ICU. The patient data can be received from, for example, the IT infrastructure 10, such as the patient information system 14, and/or an external database, such as the eICU® program database. In some embodiments, the received patient data is specific to one of an ICU, a plurality of ICUs in a region, a plurality of ICUs spanning a nation, and so on. Further, in some embodiments, the received patient data is specific to a demographic.

The plurality of variables can include one or more of patient demographics, ICU admission diagnosis, admission severity of illness determined by the Acute Physiology and Chronic Health Evaluation IV (APACHE®) score, intensive care interventions, complications occurring during the ICU stay, laboratory values and physiologic variables present during the last 24 hours, APACHE® admission diagnosis, and so on. In some embodiments, the APACHE® admission diagnoses are consolidated. For example, the diagnoses are grouped according to pathophysiology, with all rare diagnoses unrelated to newly created diagnosis groups categorized together as “Other”.

In some embodiments, the received patient data is filtered 104 to remove records for atypical patients. For example, patients with one or more of the following conditions are filtered out of the received patient data: 1) ICU length of stay less than four hours; 2) age less than 16 years; 3) ICU discharge status of death; 4) discharge location of transfer to another ICU or a location external to the medical institution; and 5) the presence of a “do not resuscitate” (DNR) or “comfort measures only” order on ICU discharge. Advantageously, this improves the effectiveness of the models since the model does not have to address fringe cases.

The patient data and the variables are then employed to identify 106 an association between the variables and the primary outcome (e.g., risk of death or risk of readmission) using multivariable logistic regression or other analytical approaches. Continuous variables can be assessed for non-linear relationships with the primary outcome using locally weighted scatterplot smoothing. Further, non-linear relationships can be addressed through transformation to linear relationships via introduction of spline terms or categorizing continuous variables. Spline terms can be introduced to create intervals of existing linear relationships which change at knots designated by, for example, visual inspection of the locally weighted scatterplot smoothing.

In some embodiments, the multivariable logistic regression includes forward and backward stepwise multivariable logistic regression or classification and regression trees so as to identify predictive variables of the primary outcome. Variables can be included in the step-wise regressions if the difference in log likelihood between the null versus extended models produces a p-value less than a predetermined value, such as 0.05, using the log-likelihood ratio test. Further interactions between covariates can be assessed using the Wald test and interactive variables with a p-value less than a predetermined value, such as 0.05, can be included in the step-wise regressions.

With reference to FIG. 6, a method 150 for assessing the readiness of a patient to be discharged from an intensive care unit (ICU) is provided. The processors 46 of the CDSS 16 suitably perform the method 150. The method 150 includes receiving 152 patient data for patients cared for by the ICU. The patient data suitably includes data indicative of physiological parameters of the patients. Further, the patient data is suitably received from the IT infrastructure 10, such as from the patient information system 14. In some embodiments, an ROD predictive model is selected 154 from a plurality of ROD predictive models in the ROD database 38, and an ROR predictive model is selected 156 from a plurality of ROR predictive models in the ROR database 40. RODs for the patients of the ICU are calculated 158 based on an ROD predictive model. In some embodiments, the ROD predictive model is the selected ROD predictive model. RORs for the patients of the ICU are also calculated 160 based on an ROR predictive model. In some embodiments, the ROR predictive model is the selected ROR predictive model. Based on the calculations, a risk of discharge is determined 162 for a selected one of the plurality of patients. The risk of discharge can be selected with a user input device, such as the user input devices 42. The risk of discharge for the selected patient is presented 164 to a clinician via a report or a user interface. For example, a clinician is presented an ROD for a patient on the display devices 44. In some embodiments, the method further includes receiving outcome data 166 identifying whether discharged patients died and/or were readmitted, optionally with a predetermined period, such as 48 hours. Based on the outcome data, the ROD models and/or ROR models are updated 168, optionally in accordance with the method 100 of FIG. 5.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet/Intranet server from which the stored instructions may be retrieved via the Internet/Intranet or a local area network; or so forth. Further, as used herein, a processor includes one or more of a microprocessor, a microcontroller, a graphic processing unit (GPU), an application-specific integrated circuit (ASIC), a field-programmable gate array (FPGA), and the like; a user input device includes one or more of a mouse, a keyboard, a touch screen display, one or more buttons, one or more switches, one or more toggles, and the like; and a display device includes one or more of a LCD display, an LED display, a plasma display, a projection display, a touch screen display, and the like.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A system for assessing the readiness of a patient to be discharged from an intensive care unit (ICU), hospital or other monitored clinical care setting to a less intensively monitored location, said system comprising:
one or more processor programmed to:
receive patient data for patients;
calculate risks of death from discharge for the patients using a first predictive model of risk of death;
calculate risks of readmission for the patients using a second predictive model of risk of readmission;
determining a risk of discharge from the risks of death and the risks of readmission; and,
present the risk of discharge for a selected one or more of the patients to a clinician or clinicians.

2. The system according to claim 1, wherein the processors are further programmed to:
receive outcome data identifying whether patients died and/or were readmitted after discharge; and,
update the first predictive model and/or the second predictive model using on the outcome data.

3. The system according to claim 2, wherein newly received outcome data is weighted more heavily than older outcome data when updating the first predictive model and/or the second predictive model.

4. The system according claim 1, wherein the first predictive model and/or the second predictive model include one or more of logistic regression, multinomial logistic regression, linear regression, and support vector machine.

5. The system according to claim 4, wherein the first predictive model and/or the second predictive models include a plurality of coefficients and/or support vectors corresponding to different predictive variables.

6. The system according to claim 1, wherein the first predictive model and/or the second predictive model are specific to monitored health care settings.

7. The system according to claim 1, wherein the first predictive model and/or the second predictive model are generic to a plurality of clinical monitoring environments.

8. The system according to claim 1, further including:
a display device, wherein the risk of discharge is presented to the clinician via the display device.

9. The system according to claim 1, wherein the presenting includes displaying the risk of discharge as indicative of severity of risk.

10. The system according to claim 9, wherein the icons correspond to one or more of low risk, moderate risk and high risk, and wherein the presenting further includes displaying a probability for the risk of death and/or the risk of readmission in response to an icon corresponding to moderate or high risk.

11. The system according to claim 1, wherein the first predictive model and/or the second predictive model predict risk of death and/or risk of readmission within a predetermined period of time.

12. An IT infrastructure comprising:
the system according to claim 1; and,
a data producer generating patient data for the patient, the patient data including data indicative of physiological parameters employed by the first predictive model and/or the second predictive;
wherein the patient data received by the system includes patient data generated by the data producer.

13. A method for assessing the readiness of a patient to be discharged from an intensive care unit (ICU), hospital or other monitored clinical care setting to a less intensively monitored location, said method comprising:
receiving patient data for patients;
calculating risks of death from discharge for the patients using a first predictive model of risk of death;
calculating risks of readmission for e patients using a second predictive model of risk of readmission;
determining risk of discharge from the risks of death and the risks of readmission; and,
presenting the risk of discharge for a selected one of the patients to a clinician.

14. The method according to claim 13, further including:
receiving outcome data identifying whether patients died and/or were readmitted after discharge; and,
updating the first predictive model and/or the second predictive model based on the outcome data.

15. The method according to claim 13, wherein the first predictive model and/or the second predictive model include one or more of logistic regression, multinomial logistic regression, linear regression, and support vector machine.

16. The method according to claim 13, wherein the presenting includes displaying the risk of discharge as indicative of severity of risk.

17. The method according to claim 16, wherein the icons correspond to one or more of low risk, moderate risk and high risk, and wherein the presenting further includes displaying a probability for the risk of death and/or the risk of readmission in response to an icon corresponding to moderate or higher risk.

18. The method according to claim 13, wherein the first predictive model and/or the second predictive model predict risk of death and/or risk of readmission within a predetermined period of time.

19. One or more processors programmed to perform the method according to claim 13.

20. A non-transitory computer readable medium carrying software which controls one or more processors to perform the method according to claim 13.
